(19) United States
(12) Patent Application Publication
(10) Pub. No.: US 2017/0240849 A1
(43) Pub. Date: Aug. 24, 2017

(54) DETERGENT AND CLEANING AGENTS HAVING IMPROVED PERFORMANCE

(71) Applicant: Henkel AG & Co. KGaA, Duesseldorf (DE)

(72) Inventors: Christian Kropf, Hilden (DE); Nadine Bluhm, Duesseldorf (DE); Christian Umbreit, Neuss (DE); Hendrik Hellmuth, Darmstadt (DE); Michael Strotz, Koeln (DE); Kaspar Hegetschweiler, St. Ingbert (DE)

(73) Assignee: Henkel AG & Co. KGaA, Duesseldorf (DE)

(21) Appl. No.: 15/589,336

(22) Filed: May 8, 2017

Related U.S. Application Data
(63) Continuation of application No. PCT/EP2015/075078, filed on Oct. 29, 2015.

(30) Foreign Application Priority Data
Nov. 10, 2014 (DE) 102014222833.6

(51) Int. Cl. C11D 11/00; C11D 3/32; C11D 3/20

(52) U.S. Cl. CPC C11D 11/0017; C11D 3/2086; C11D 3/2093; C11D 3/32

(57) ABSTRACT

The present invention relates to the use of dihydroxyterephthalic acid derivatives in washing and cleaning agents for improving the washing or cleaning performance with respect to bleachable stains.

### FIELD OF THE INVENTION

The present invention generally relates to the use of dihydroxyterephthalic acid derivatives in washing and cleaning agents for improving the washing or cleaning performance.

### BACKGROUND OF THE INVENTION

While the formulation of powdered washing and cleaning agents containing bleaching agent(s) no longer presents any problems today, the formulation of stable, liquid washing and cleaning agents containing bleaching agent(s) continues to pose a problem. Since liquid washing and cleaning agents usually contain no bleaching agent, those stains that are normally removed in particular due to the incorporated bleaching agents are thus often only insufficiently removed. A similar problem also exists for color washing agents which are free of bleaching agents, in which the bleaching agent is omitted in order to protect the dyes in the textile and prevent the bleaching thereof. If there is no bleaching agent, a further complication is that, instead of removing the so-called bleachable stains which are normally at least partially removed by the use of a peroxygen-based bleaching agent, on the contrary the stain is often even intensified and/or made more difficult to remove as a result of the washing process, not least because of initiated chemical reactions which may consist for example in the polymerization of certain dyes contained in the stains.

Such problems occur in particular in the case of stains which contain polymerizable substances. The polymerizable substances are especially polyphenolic dyes, preferably flavonoids, in particular from the class of the anthocyanidins or anthocyanins. The stains may in particular have been caused by food products or beverages which contain such dyes. The stains may in particular be fruit or vegetable stains or else red wine stains which contain in particular polyphenolic dyes, especially those from the class of the anthocyanidins or anthocyanins.

International patent application WO 2011023716 A1 discloses the use of gallic acid esters such as propyl gallate in washing and cleaning agents for the improved removal of stains which contain polymerizable substances.

International patent application WO 2013092263 A1 deals with improving the performance of washing and cleaning agents by using oligohydroxybenzamides.

Accordingly, it is desirable to have novel washing and cleaning agents for improving the washing or cleaning performance with respect to bleachable stains. In addition, it is desirable to have an improved method that enhances the washing or cleaning performance with respect to bleachable stains. Furthermore, other desirable features and characteristics of the present invention will become apparent from the subsequent detailed description of the invention and the appended claims, taken in conjunction with this background of the invention.

### BRIEF SUMMARY OF THE INVENTION

A first subject matter of the present invention is therefore the use of compounds of general formula (I)

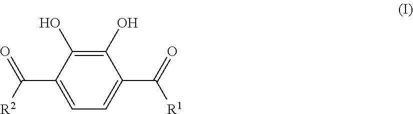

in which R¹ and R² independently of one another are NR³R⁴ or OR⁵, and R³, R⁴ and R⁵ independently of one another are H or a cyclic or acyclic, straight-chain or branched-chain, aliphatic or aromatic hydrocarbon residue having 1 to 20, preferably 1 to 10 carbon atoms, the backbone of which may be interrupted by one or more non-adjacent heteroatoms, in particular selected from O and/or N, and/or which may be substituted with OH groups or NH₂ groups at C atoms not bound to heteroatoms, in washing or cleaning agents for improving the washing or cleaning performance with respect to bleachable stains.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

It has surprisingly been found that, by using dihydroxyterephthalic acid and/or dihydroxyterephthalic acid esters and/or amides, the washing or cleaning performance of washing or cleaning agents can be considerably improved in particular with respect to bleachable stains. Accordingly, a method for improving washing or cleaning performance with respect to bleachable stains is developed by providing a washing or cleaning agent comprising dihydroxyterephthalic acid and/or dihydroxyterephthalic acid esters and/or amides, followed by bringing a textile having bleachable stains into contact with the agent.

As mentioned above, bleachable stains are those which can be at least partially removed by using peroxygen-based bleaching agents, for example sodium percarbonate in combination with tetraacetylethylenediamine. The bleachable stains usually contain polymerizable substances, in particular polymerizable dyes, the polymerizable dyes preferably being polyphenolic dyes, in particular flavonoids, especially anthocyanidins or anthocyanins or oligomers of said compounds. Besides removing stains of green, yellow, red or blue color, the removal of stains of intermediate colors, in particular violet, purple, brown, magenta or pink, is also considered, as well as stains which have a green, yellow, red, violet, purple, brown, magenta, pink or blue tint without substantially themselves consisting entirely of this color. The aforementioned colors may in particular also be light or dark in each case. The stains are preferably stains caused in particular by grass, fruit or vegetables, in particular including stains caused by food products, such as for example spices, sauces, chutneys, curries, purees and jams, or beverages, such as for example coffee, tea, wines and juices, which contain corresponding green, yellow, red, violet, purple, brown, magenta, pink and/or blue dyes.

The stains to be removed according to the invention may in particular be caused by cherries, sour cherries, grapes, apples, pomegranates, aronia, plums, buckthorn, acai, kiwis, mangoes, grass or berries, in particular by redcurrants or blackcurrants, elderberries, blackberries, raspberries, blueberries, lingonberries, cranberries, strawberries or bilberries, or by coffee, tea, red cabbage, blood orange, eggplant, tomato, carrot, beetroot, spinach, bell pepper, red or blue potato, or red onion.

Among the compounds of general formula (I), preference is given to those in which R¹ and R² are identical. R³ is preferably H, and R⁴ and R⁵ independently of one another are preferably alkyl groups, such as methyl, ethyl, n-propyl or i-propyl, alkoxyalkyl groups, such as methoxyethyl, methoxypropyl, (2-methoxy)ethoxyethyl, ethoxyethyl, ethoxypropyl or (2-ethoxy)ethoxyethyl, hydroxyalkyl groups, such as hydroxyethyl, hydroxypropyl, 2-hydroxypropyl, 1,2-dihydroxypropyl, 2-hydroxyethoxyethyl, (N-hydroxyethyl)aminoethyl, (N-methoxyethyl)amino ethyl or (N-ethoxyethyl)aminoethyl, or aromatic groups, such as phenyl or benzyl.

The use according to the invention of the compound of general formula (I) in washing or cleaning agents preferably takes place in such a way that they are used in an amount of from 0.001% by weight to 20% by weight, in particular in an amount of from 0.01% by weight to 10% by weight, wherein, here and below, figures given in “% by weight” relate in each case to the weight of the total washing or cleaning agent. A further subject matter of the invention is therefore a washing or cleaning agent containing 0.001% by weight to 20% by weight, in particular 0.01% by weight to 10% by weight, of compound of general formula (I), wherein the preferred embodiments described above or below in connection with the use according to the invention also apply to this subject matter of the invention, and conversely the preferred embodiments described in connection with agents according to the invention also apply to the use aspect of the invention.

The washing or cleaning agent may exist in any administration form established in the prior art and/or in any useful administration form. These include for example solid, powdered, liquid, gel-like or paste-like administration forms, optionally also consisting of multiple phases; they also include for example: extrudates, granules, tablets or pouches, packaged either in large containers or in portions.

In one preferred embodiment, the use according to the invention takes place in a washing or cleaning agent which contains no bleaching agents. This is to be understood to mean that the agent contains no bleaching agents in the narrower sense, that is to say hypochlorites, hydrogen peroxide or substances yielding hydrogen peroxide; preferably, it also contains no bleach activators and/or bleach catalysts.

In one particularly preferred embodiment, the washing agent is a liquid textile washing agent.

In another particularly preferred embodiment, the washing agent is a powdered or liquid color washing agent, that is to say a textile washing agent for colored textiles.

The washing and cleaning agents may additionally contain other usual constituents of washing or cleaning agents, in particular textile washing agents, selected in particular from the group consisting of builders, surfactants, polymers, enzymes, disintegration auxiliaries, fragrances, and perfume carriers.

The builders include in particular zeolites, silicates, carbonates, organic cobuilders and—provided there are no ecological reasons opposing the use thereof—also phosphates.

The finely crystalline synthetic zeolite containing bound water is preferably zeolite A and/or zeolite P. Zeolite MAP® (commercial product from the company Crosfield) for example is appropriate as zeolite P. Also suitable, however, are zeolite X and also mixtures of zeolite A, X and/or P. A co-crystallizate of zeolite X and zeolite A (approximately 80% by weight zeolite X), which can be described by the formula

nNa₂O.(1-n) K₂O.Al₂O₃.(2-2.5) SiO₂.(3.5-5.5) H₂O

is also available commercially for example and can be used in the context of the present invention. The zeolite may be used both as a builder in a granular compound and as a kind of “dusting” on a granular mixture, preferably a mixture to be compressed, wherein usually both approaches are used to incorporate the zeolite into the pre-mixture. Zeolites may have a mean particle size of less than 10 μm (volume distribution; measurement method: Coulter Counter) and preferably contain from 18% by weight to 22% by weight, in particular from 20% by weight to 22% by weight, of bound water.

Use may also be made of crystalline phyllosilicates of general formula NaMSiₓO₂ₓ₊₁.y H₂O, in which M is sodium or hydrogen, x is a number from 1.9 to 22, preferably from 1.9 to 4, particularly preferred values for x being 2, 3 or 4, and y is a number from 0 to 33, preferably from 0 to 20. The crystalline phyllosilicates of formula NaMSiₓO₂ₓ₊₁.y H₂O are distributed for example by the company Clariant GmbH (Germany) under the trade name Na-SKS. Examples of these silicates are Na-SKS-1 (Na₂Si₂₂O₄₅.x H₂O, kenyaite), Na-SKS-2 (Na2Si₁₄O₂₉.x H₂O, magadiite), Na-SKS-3 (Na₂Si₈O₁₇.x H₂O) or Na-SKS-4 (Na₂Si₄O₉.x H₂O, makatite).

Preference is given to crystalline phyllosilicates of formula NaMSiₓO₂ₓ₊₁.y H₂O in which x is 2. Particular preference is given to both β- and δ-sodium disilicates Na₂Si₂O₅.y H₂O, and especially to Na-SKS-5 (α-Na₂Si₂O₅), Na-SKS-7 (β-Na₂Si₂O₅, natrosilite), Na-SKS-9 (NaHSi₂O₅.H₂O), Na-SKS-10 (NaHSi₂O₅.3H₂O, kanemite), Na-SKS-11 (t-Na₂Si₂O₅) and Na-SKS-13 (NaHSi₂O₅), but particularly to Na-SKS-6 (67 -Na₂Si₂O₅). Washing or cleaning agents preferably contain a proportion by weight of the crystalline phyllosilicate of formula NaMSiₓO_{2X+1}.y H₂O of from 0.1% by weight to 20% by weight, preferably from 0.2% by weight to 15% by weight, and in particular from 0.4% by weight to 10% by weight.

Use can also be made of amorphous sodium silicates having a modulus Na₂O: SiO₂ of from 1:2 to 1:3.3, preferably from 1:2 to 1:2.8 and in particular from 1:2 to 1:2.6, which are preferably dissolution-delayed and exhibit secondary washing properties. The dissolution delay in comparison to conventional amorphous sodium silicates may have been brought about in various ways, for example by surface treatment, compounding, compacting/compression, or by overdrying. The term “amorphous” will be understood to mean that the silicates, in X-ray diffraction experiments, do not yield any sharp X-ray reflections as are typical of crystalline substances, but rather at most produce one or more maxima of the scattered X radiation that have a width of several degree units of the diffraction angle.

As an alternative to or in combination with the aforementioned amorphous sodium silicates, use can also be made of X-ray amorphous silicates, the silicate particles of which yield blurred or even sharp diffraction maxima in electron beam diffraction experiments. This is to be interpreted to mean that the products have microcrystalline regions of a size measuring ten to several hundred nm, preference being given to values up to a maximum of 50 nm and in particular up to a maximum of 20 nm. Such X-ray amorphous silicates likewise exhibit a dissolution delay in comparison to conventional waterglasses. Particular preference is given to compressed/compacted amorphous silicates, compounded amorphous silicates and overdried X-ray amorphous silicates.

Said silicate(s), preferably alkali silicates, particularly preferably crystalline or amorphous alkali disilicates, are, if present, contained in washing or cleaning agents in amounts of from 3% by weight to 60% by weight, preferably from 8% by weight to 50% by weight, and in particular from 20% by weight to 40% by weight.

It is also possible to use the generally known phosphates as builder substances, provided that such a use is not to be avoided for ecological reasons. Among the many commercially available phosphates, the most significant in the washing and cleaning agent industry are the alkali metal phosphates, particularly preferably pentasodium and pentapotassium triphosphate (sodium and potassium tripolyphosphate).

“Alkali metal phosphates” is the universal designation for the alkali metal (in particular sodium and potassium) salts of the various phosphoric acids, in respect of which a distinction can be made between metaphosphoric acids (HPO₃) and orthophosphoric acid H₃PO₄, in addition to higher-molecular-weight representatives. The phosphates combine a number of advantages: they act as alkali carriers, prevent lime deposits on machine parts or lime incrustations in fabrics, and moreover contribute to the cleaning performance. Particularly important phosphates from a technical point of view are pentasodium triphosphate, Na₅P₃O₁₀ (sodium tripolyphosphate) and the corresponding potassium salt pentapotassium triphosphate, K₅P₃O₁₀ (potassium tripolyphosphate). Sodium potassium tripolyphosphates are also used with preference. If phosphates are used in washing or cleaning agents, then preferred agents contain said phosphate(s), preferably alkali metal phosphate(s), particularly preferably pentasodium or pentapotassium triphosphate (sodium or potassium tripolyphosphate), in amounts of from 5% by weight to 80% by weight, preferably from 15% by weight to 75% by weight, and in particular from 20% by weight to 70% by weight.

Alkali carriers can also be used. Alkali carriers are considered to be for example alkali metal hydroxides, alkali metal carbonates, alkali metal hydrogen carbonates, alkali metal sesquicarbonates, the aforementioned alkali silicates, alkali metasilicates, and mixtures of the aforementioned substances; the alkali carbonates, in particular sodium carbonate, sodium hydrogen carbonate or sodium sesquicarbonate, are used with preference. A builder system containing a mixture of tripolyphosphate and sodium carbonate may be particularly preferred. Because of their chemical compatibility with the other ingredients of washing or cleaning agents, which is low in comparison to other builder substances, the alkali metal hydroxides are usually used only in small amounts, preferably in amounts below 10% by weight, more preferably below 6% by weight, particularly preferably below 4% by weight and in particular below 2% by weight. Particular preference is given to agents which contain, based on their total weight, less than 0.5% by weight and in particular no alkali metal hydroxides. Preference is given to the use of carbonate(s) and/or hydrogen carbonate(s), preferably alkali carbonate(s), particularly preferably sodium carbonate, in amounts of from 2% by weight to 50% by weight, preferably from 5% by weight to 40% by weight and in particular from 7.5% by weight to 30% by weight.

As organic builders, mention may be made in particular of polycarboxylates/polycarboxylic acids, polymeric polycarboxylates, aspartic acid, polyacetals, dextrins and phosphonates. Use can be made for example of the polycarboxylic acids which can be used in the form of the free acid and/or the sodium salts thereof, polycarboxylic acids being understood to mean those carboxylic acids which carry more than one acid function. Examples of these are citric acid, adipic acid, succinic acid, glutaric acid, malic acid, tartaric acid, maleic acid, fumaric acid, sugar acids, aminocarboxylic acids and nitrilotriacetic acid (NTA), provided that such a use is not objectionable for ecological reasons, as well as mixtures thereof. The free acids typically have, besides their builder effect, also the property of an acidifying component and thus serve also to establish a lower and milder pH of washing or cleaning agents. In particular, mention may be made here of citric acid, succinic acid, glutaric acid, adipic acid, gluconic acid and any mixtures thereof. Polymeric polycarboxylates are also suitable as builders; these are for example the alkali metal salts of polyacrylic acid or of polymethacrylic acid, for example those having a relative molecular mass of from 500 g/mol to 70,000 g/mol. Polyacrylates which preferably have a molecular mass of from 2,000 g/mol to 20,000 g/mol are particularly suitable. Among this group, due to their superior solubility, preference may in turn be given to the short-chain polyacrylates which have molar masses of from 2,000 g/mol to 10,000 g/mol, and particularly preferably from 3,000 g/mol to 5,000 g/mol. Also suitable are copolymeric polycarboxylates, in particular those of acrylic acid with methacrylic acid and of acrylic acid or methacrylic acid with maleic acid. Copolymers of acrylic acid with maleic acid which contain 50% by weight to 90% by weight acrylic acid and 50% by weight to 10% by weight maleic acid have proven to be particularly suitable. The relative molecular mass thereof, based on free acids, is generally from 2,000 g/mol to 70,000 g/mol, preferably from 20,000 g/mol to 50,000 g/mol and in particular from 30,000 g/mol to 40,000 g/mol. To improve the water solubility, the polymers may also contain allylsulfonic acids, such as for example allyloxybenzenesulfonic acid and methallylsulfonic acid, as monomers. The (co)polymeric polycarboxylates may be used in solid form or in aqueous solution. The content of (co)polymeric polycarboxylates in washing or cleaning agents is preferably from 0.5% by weight to 20% by weight and in particular from 3% by weight to 10% by weight.

Particular preference is also given to biodegradable polymers composed of more than two different monomer units, for example those which contain, as monomers, salts of acrylic acid and of maleic acid as well as vinyl alcohol or vinyl alcohol derivatives, or which contain, as monomers, salts of acrylic acid and of 2-alkylallylsulfonic acid as well as sugar derivatives. Other preferred copolymers are those which comprise, as monomers, acrolein and acrylic acid/acrylic acid salts or acrolein and vinyl acetate. As further preferred builder substances, mention can also be made of polymeric aminodicarboxylic acids, salts thereof, or precursor substances thereof. Particular preference is given to polyaspartic acids and/or salts thereof

The phosphonates represent another substance class having builder properties. These are the salts of in particular hydroxyalkanephosphonic or aminoalkanephosphonic acids. Among the hydroxyalkanephosphonic acids, 1-hydroxyethane-1, 1-dip ho sphonate (HEDP) is of particular importance. It is used in particular in the form of the sodium salt, the disodium salt reacting neutrally and the tetrasodium salt reacting in an alkaline fashion. Suitable aminoalkanephosphonic acids are in particular ethylenediaminetetramethylenephosphonic acid (EDTMP), diethylenetriaminepentamethylenephosphonic acid (DTPMP), and higher homologs thereof. They are used in particular in the form of the neutrally reacting sodium salts, for example as the hexasodium salt of EDTMP or as the heptasodium and octasodium salt of DTPMP. Mixtures of the aforementioned phosphonates can also be used as organic builders. Aminoalkanephosphonates in particular also have a pronounced heavy-metal binding capability.

Further suitable builder substances are polyacetals, which can be obtained by reacting dialdehydes with polyolcarboxylic acids containing 5 to 7 C atoms and at least 3 hydroxyl groups. Preferred polyacetals are obtained from dialdehydes such as glyoxal, glutaraldehyde, terephthalaldehyde and mixtures thereof, and from polyolcarboxylic acids such as gluconic acid and/or glucoheptonic acid.

Further suitable organic builder substances are dextrins, for example oligomers or polymers of carbohydrates, which can be obtained by partial hydrolysis of starches. The hydrolysis can be carried out in accordance with routine methods, for example acid-catalyzed or enzyme-catalyzed methods. These are preferably hydrolysis products having mean molar masses in the range from 400 g/mol to 500,000 g/mol. Preference is given to a polysaccharide having a dextrose equivalent (DE) in the range from 0.5 to 40, in particular from 2 to 30, DE being a common indicator of the reducing effect of a polysaccharide in comparison to dextrose, which has a DE of 100. Use can be made of both maltodextrins having a DE between 3 and 20 and dry glucose syrups having a DE between 20 and 37, as well as so-called yellow dextrins and white dextrins having higher molar masses in the range from 2,000 g/mol to 30,000 g/mol. The oxidized derivatives of such dextrins are the reaction products thereof with oxidizing agents which are capable of oxidizing at least one alcohol function of the saccharide ring to the carboxylic acid function.

Further suitable cobuilders are also oxydisuccinates and other derivatives of disuccinates, preferably ethylenediamine disuccinate. Ethylenediamine-N,N′-disuccinate (EDDS) is preferably used in the form of its sodium or magnesium salts. In this connection, preference is also given to glycerol disuccinates and glycerol trisuccinates. If desired, suitable use amounts particularly in zeolite-containing and/or silicate-containing formulations are 3% by weight to 15% by weight.

Other organic cobuilders which can be used are for example acetylated hydroxycarboxylic acids or salts thereof, which may optionally also be in lactone form and which contain at least 4 carbon atoms and at least one hydroxyl group and at most two acid groups.

All compounds capable of forming complexes with alkaline earth ions can also be used as builders.

Washing and cleaning agents may contain nonionic, anionic, cationic and/or amphoteric surfactants.

As nonionic surfactants, use can be made of all nonionic surfactants known to a person skilled in the art. With particular preference, washing or cleaning agents contain nonionic surfactants from the group consisting of alkoxylated alcohols. The nonionic surfactants used are preferably alkoxylated, advantageously ethoxylated, in particular primary alcohols having preferably 8 to 18 C atoms and on average 1 to 12 mol of ethylene oxide (EO) per mole of alcohol, in which the alcohol residue may be linear or preferably methyl-branched in the 2-position, or may contain a mixture of linear and methyl-branched residues, such as those usually present in oxo alcohol residues. However, particular preference is given to alcohol ethoxylates having linear residues made up of alcohols of native origin having 12 to 18 C atoms, for example from coconut, palm, tallow fatty alcohol or oleyl alcohol, and on average 2 to 8 mol of EO per mole of alcohol. The preferred ethoxylated alcohols include for example C₁₂₋₁₄ alcohols with 3 EO or 4 EO, C₉₋₁₁ alcohols with 7 EO, C₁₃₋₁₅ alcohols with 3 EO, 5 EO, 7 EO or 8 EO, C₁₂₋₁₈ alcohols with 3 EO, 5 EO or 7 EO, and mixtures thereof, such as mixtures of C₁₂₋₁₄ alcohol with 3 EO and C₁₂₋₁₈ alcohol with 5 EO. The specified degrees of ethoxylation are statistical averages that can correspond to an integral or a fractional number for a specific product. Preferred alcohol ethoxylates have a narrow homolog distribution (narrow range ethoxylates, NREs).

As an alternative or in addition to said nonionic surfactants, use can also be made of fatty alcohols with more than 12 EO. Examples of these are tallow fatty alcohol with 14 EO, 25 EO, 30 EO or 40 EO. As further nonionic surfactants, use can also be made of alkylglycosides of general formula RO(G)ₓ, in which R is a primary straight-chain or methyl-branched aliphatic residue, in particular methyl-branched in the 2-position, having 8 to 22, preferably 12 to 18 C atoms, and G is the symbol denoting a glycose unit having 5 or 6 C atoms, preferably glucose. The degree of oligomerization x, which indicates the distribution of monoglycosides and oligoglycosides, is any number between 1 and 10; x is preferably 1.2 to 1.4.

A further class of nonionic surfactants used with preference, which are used either as the only nonionic surfactant or in combination with other nonionic surfactants, is formed by alkoxylated, preferably ethoxylated or ethoxylated and propoxylated fatty acid alkyl esters, preferably having 1 to 4 carbon atoms in the alkyl chain.

Use can also be made of nonionic surfactants of the amine oxide type, for example N-cocoalkyl-N,N-dimethylamine oxide and N-tallowalkyl-N,N-dihydroxyethylamine oxide, and of fatty acid alkanolamides. The amount of said nonionic surfactants is preferably no more than that of the ethoxylated fatty alcohols, in particular no more than half thereof.

Further suitable surfactants are polyhydroxy fatty acid amides of formula

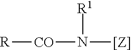

in which R is an aliphatic acyl residue having 6 to 22 carbon atoms, R¹ is hydrogen, an alkyl or hydroxyalkyl residue having 1 to 4 carbon atoms, and [Z] is a linear or branched polyhydroxyalkyl residue having 3 to 10 carbon atoms and 3 to 10 hydroxyl groups. Polyhydroxy fatty acid amides are known substances which can usually be obtained by reductive amination of a reducing sugar with ammonia, an alkylamine or an alkanolamine, followed by acylation with a fatty acid, a fatty acid alkyl ester or a fatty acid chloride. The group of polyhydroxy fatty acid amides also includes compounds of formula

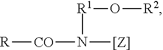

in which R is a linear or branched alkyl or alkenyl residue having 7 to 12 carbon atoms, R¹ is a linear, branched or cyclic alkyl residue or an aryl residue having 2 to 8 carbon atoms, and R² is a linear, branched or cyclic alkyl residue or an aryl residue or an oxyalkyl residue having 1 to 8 carbon atoms, preference being given to C₁₋₄ alkyl or phenyl residues, and [Z] is a linear polyhydroxyalkyl residue, the alkyl chain of which is substituted with at least two hydroxyl groups, or alkoxylated, preferably ethoxylated or propoxylated derivatives of said residue. [Z] is preferably obtained by reductive amination of a reduced sugar, for example glucose, fructose, maltose, lactose, galactose, mannose or xylose. The N-alkoxy-or N-aryloxy-substituted compounds can be converted into the desired polyhydroxy fatty acid amides by reaction with fatty acid methyl esters in the presence of an alkoxide as catalyst.

In cleaning agents, particular preference is given to nonionic surfactants from the group of alkoxylated alcohols, particularly preferably from the group of mixed alkoxylated alcohols and in particular from the group of EO/AO/EO nonionic surfactants or PO/AO/PO nonionic surfactants, especially PO/EO/PO nonionic surfactants. Such PO/EO/PO nonionic surfactants are characterized by good foam control.

As anionic surfactants, use can be made for example of those of the sulfonate and sulfate type. Suitable surfactants of the sulfonate type are for example preferably C₉₋₁₃ alkylbenzenesulfonates, olefinsulfonates, that is to say mixtures of alkene- and hydroxyalkanesulfonates, and disulfonates, as obtained for example from C₁₂₋₁₈ monoolefins having a terminal or internal double bond by sulfonation with gaseous sulfur trioxide and subsequent alkaline or acid hydrolysis of the sulfonation products. Also suitable are alkanesulfonates which are obtained from C₁₂₋₁₈ alkanes for example by sulfochlorination or sulfoxidation with subsequent hydrolysis or neutralization. Also suitable are the esters of α-sulfo fatty acids (estersulfonates), for example the α-sulfonated methyl esters of hydrogenated coconut, palm kernel or tallow fatty acids.

Further suitable anionic surfactants are sulfonated fatty acid glycerol esters. Fatty acid glycerol esters are to be understood to mean the mono-, di- and triesters, and mixtures thereof, that are obtained in the context of manufacture by esterification of a monoglycerol with 1 to 3 mol of fatty acid, or upon transesterification of triglycerides with 0.3 to 2 mol of glycerol. Preferred sulfonated fatty acid glycerol esters are the sulfonation products of saturated fatty acids having 6 to 22 carbon atoms, for example caproic acid, caprylic acid, capric acid, myristic acid, lauric acid, palmitic acid, stearic acid or behenic acid.

As alk(en)yl sulfates, preference is given to the alkali salts, and in particular the sodium salts, of the sulfuric acid semiesters of C₁₂-C₁₈ fatty alcohols, for example from coconut fatty alcohol, tallow fatty alcohol, lauryl, myristyl, cetyl or stearyl alcohol, or C₁₀-C₂₀ oxo alcohols, and those semiesters of secondary alcohols of said chain lengths. Preference is also given to alk(en)yl sulfates of the aforementioned chain length which contain a synthetic, straight-chain alkyl residue produced on a petrochemical basis, which has a breakdown behavior analogous to those appropriate compounds based on fat-chemistry raw materials. From the point of view of the washing industry, preference is given to the C₁₂-C₁₆ alkyl sulfates and C₁₂-C₁₅ alkyl sulfates, as well as C₁₄-C₁₅ alkyl sulfates.

Also suitable are the sulfuric acid monoesters of straight-chain or branched C₇₋₂₁ alcohols ethoxylated with 1 to 6 mol of ethylene oxide, such as 2-methyl-branched C₉₋₁₁ alcohols with on average 3.5 mol of ethylene oxide (EO) or C₁₂₋₁₈ fatty alcohols with 1 to 4 EO. Because of their high-foaming behavior, they are used in cleaning agents only in relatively small amounts, for example in amounts of from 1% by weight to 5% by weight.

Other suitable anionic surfactants are also the salts of alkylsulfosuccinic acid, which are also referred to as sulfosuccinates or as sulfosuccinic acid esters and which are monoesters and/or diesters of sulfosuccinic acid with alcohols, preferably fatty alcohols, and in particular ethoxylated fatty alcohols. Preferred sulfosuccinates contain C₈₋₁₈ fatty alcohol residues or mixtures thereof. Particularly preferred sulfosuccinates contain a fatty alcohol residue derived from ethoxylated fatty alcohols which, considered per se, are nonionic surfactants. Particular preference is in turn given to sulfosuccinates whose fatty alcohol residues derive from ethoxylated fatty alcohols with a narrow homolog distribution. It is likewise also possible to use alk(en)ylsuccinic acid having preferably 8 to 18 carbon atoms in the alk(en)yl chain, or salts thereof.

Further suitable anionic surfactants are in particular soaps. Saturated fatty acid soaps, such as the salts of lauric acid, myristic acid, palmitic acid, stearic acid, hydrogenated erucic acid and behenic acid, and in particular soap mixtures derived from natural fatty acids, for example coconut, palm kernel or tallow fatty acids, are suitable.

The anionic surfactants, including the soaps, can be present in the form of their sodium, potassium or ammonium salts and as soluble salts of organic bases, such as mono-, di- or triethanolamine. Preferably, the anionic surfactants are present in the form of their sodium or potassium salts, in particular in the form of sodium salts.

Instead of the aforementioned surfactants, or in conjunction therewith, use can also be made of cationic and/or amphoteric surfactants.

As cationic active substances, use can be made for example of cationic compounds of the following formulae:

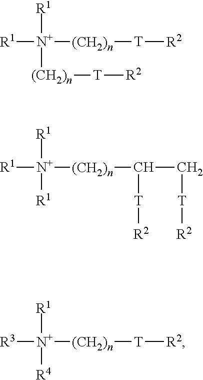

in which each group R¹, independently of one another, is selected from C₁₋₆ alkyl, alkenyl or hydroxyalkyl groups; each group R², independently of one another, is selected from C₈₋₂₈ alkyl or alkenyl groups; R³=R¹ or (CH₂)ₙ-T-R²; R⁴=R¹ or R² or (CH₂)ₙ-T-R²; T=—CH₂—, —O—OC— or —CO—O—, and n is an integer from 0 to 5.

Textile-softening compounds can be used for textile care and in order to improve the textile properties, such as a softer “feel” (avivage) and reduced electrostatic charge (increased wearing comfort). The active substances of said formulations are quaternary ammonium compounds having two hydrophobic residues, such as for example distearyldimethylammonium chloride, but due to its insufficient biodegradability the latter is increasingly being replaced by quaternary ammonium compounds which contain ester groups in their hydrophobic residues as defined break points for biodegradation.

Such “esterquats” with improved biodegradability can be obtained for example by esterifying mixtures of methyl diethanolamine and/or triethanolamine with fatty acids and then quaternizing the reaction products with alkylating agents in a manner known per se. Dimethylolethylene urea is additionally suitable as a finish.

Enzymes can be used to increase the performance of washing or cleaning agents. Said enzymes include in particular proteases, amylases, lipases, hemicellulases, cellulases, perhydrolases or oxidoreductases, and preferably mixtures thereof. Said enzymes are in principle of natural origin; proceeding from the natural molecules, improved variants are available for use in washing and cleaning agents and are accordingly used with preference. Washing or cleaning agents contain enzymes preferably in total amounts of from 1×10 ⁻⁶% by weight to 5% by weight, based on active protein. The protein concentration can be determined by known methods, for example the BCA method or the biuret method.

Among the proteases, preference is given to those of the subtilisin type. Examples of these are the subtilisins BPN′ and Carlsberg, as well as the further developed forms thereof, the protease PB92, the subtilisins 147 and 309, the alkaline protease from Bacillus lentus, subtilisin DY, and the enzymes (assigned to the subtilases but no longer to the subtilisins in the narrower sense) thermitase, proteinase K and the proteases TW3 and TW7.

Examples of amylases which can be used are the α-amylases from Bacillus licheniformis, from B. amyloliquefaciens, from B. stearothermophilus, from Aspergillus niger and A. oryzae, and the further developments of the aforementioned amylases improved for use in washing and cleaning agents. Additionally to be highlighted for this purpose are the α-amylase from Bacillus sp. A 7-7 (DSM 12368) and the cyclodextrin-glucanotransferase (CGTase) from B. agaradherens (DSM 9948).

Due to their triglyceride-cleaving activity, use can also be made of lipases or cutinases. These include for example the lipases obtainable originally from Humicola lanuginosa (Thermomyces lanuginosus) or lipases further developed therefrom, in particular those having the D96L amino acid exchange. Use can also be made for example of the cutinases that were originally isolated from Fusarium solani pisi and Humicola insolens. Lipases and/or cutinases whose starting enzymes were originally isolated from Pseudomonas mendocina and Fusarium solanii can also be used.

Use can also be made of enzymes which are grouped under the term hemicellulases. These include for example mannanases, xanthanlyases, pectinlyases (=pectinases), pectinesterases, pectatelyases, xyloglucanases (=xylanases), pullulanases and β-glucanases.

In order to increase the bleaching effect, use can also be made, if desired, of oxidoreductases, for example oxidases, oxygenases, catalases, peroxidases, such as halo-, chloro-, bromo-, lignin, glucose or manganese peroxidases, dioxygenases, or laccases (phenoloxidases, polyphenoloxidases). Advantageously, preferably organic, particularly preferably aromatic compounds which interact with the enzymes are additionally added in order to enhance the activity of the relevant oxidoreductases (enhancers) or, if there is a large difference in redox potential between the oxidizing enzymes and the stains, to ensure the electron flow (mediators).

The enzymes can be used in any form established in the prior art. This includes for example the solid preparations obtained by granulation, extrusion or lyophilization or, particularly in the case of liquid or gel-like agents, solutions of the enzymes, advantageously as concentrated as possible, low in water and/or with added stabilizers. Alternatively, the enzymes can be encapsulated both for the solid and for the liquid administration form, for example by spray drying or extrusion of the enzyme solution together with a preferably natural polymer, or in the form of capsules, for example those in which the enzymes are enclosed, such as in a solidified gel, or in those of the core-shell type, in which an enzyme-containing core is coated with a protective layer that is impermeable to water, air, and/or chemicals. Further active substances, for example stabilizers, emulsifiers, pigments, bleaches or dyes, can additionally be applied in superimposed layers. Such capsules are applied using methods known per se, for example by vibratory or roll granulation or in fluidized bed processes. Advantageously, such granulates are low in dust, for example as a result of the application of polymeric film formers, and are storage-stable on account of the coating. Furthermore, it is possible to package two or more enzymes together so that a single granulate exhibits multiple enzyme activities.

Use is preferably made of one or more enzymes and/or enzyme preparations, preferably protease preparations and/or amylase preparations, in amounts of from 0.1% by weight to 5% by weight, preferably from 0.2% by weight to 4.5% by weight and in particular from 0.4% by weight to 4% by weight.

As perfume oils or scents, use can be made of individual fragrance compounds, for example synthetic products of the ester, ether, aldehyde, ketone, alcohol or hydrocarbon type. However, it is preferred to use mixtures of different fragrances that together generate an attractive scent note. Such perfume oils can also contain natural fragrance mixtures such as those accessible from plant sources, for example pine, citrus, jasmine, patchouli, rose or ylang-ylang oil. In order to be perceptible, a fragrance must be volatile; in addition to the nature of the functional groups and the structure of the chemical compound, the molar mass also plays an important part. Most fragrances, for example, have molar masses of up to approximately 200 g/mol, while molar masses of 300 g/mol and above represent something of an exception. Because of the differing volatility of fragrances, the odor of a perfume or scent made up of multiple fragrances changes during volatilization, the odor impressions being subdivided into a “top note,” “middle note” or “body,” and “end note” or “dry out”. Because the perception of an odor also depends a great deal on the odor intensity, the top note of a perfume or scent is not made up only of highly volatile compounds, while the end note comprises for the most part less-volatile fragrances, that is to say adherent fragrances. In the compounding of perfumes, more-volatile fragrances can for example be bound to specific fixatives, thereby preventing them from volatilizing too quickly. The division below of fragrances into “more-volatile” and “adherent” fragrances therefore makes no statement with regard to the odor impression, or as to whether the corresponding fragrance is perceived as a top or middle note. The scents can be processed directly, but it can also be advantageous to apply the scents onto carriers that ensure a slower scent release for a lasting scent. Cyclodextrins, for example, have proven successful as such carrier materials; the cyclodextrin-perfume complexes can additionally be coated with further auxiliaries.

When selecting the coloring agent, care must be taken to ensure that the coloring agents exhibit excellent storage stability and insensitivity to light, and they cannot have too strong an affinity with respect to textile surfaces and, particularly in this case, toward synthetic fibers. At the same time, it must also be considered that coloring agents have differing levels of stability with respect to oxidation. It is generally the case that water-insoluble coloring agents are more stable with respect to oxidation than water-soluble coloring agents. The concentration of the coloring agent in the washing or cleaning agents varies as a function of solubility and thus also of oxidation sensitivity. For readily water-soluble coloring agents, coloring-agent concentrations in the range of a few 10⁻²% by weight to 10⁻³% by weight are typically selected. In the case of pigment dyes, on the other hand, which are particularly preferred because of their brilliance but are less readily water-soluble, the appropriate concentration of the coloring agent in washing or cleaning agents is typically a few 10⁻³% by weight to 10⁻⁴% by weight. Preference is given to coloring agents which can be oxidatively destroyed in the washing process, as well as mixtures thereof with suitable blue dyes, so-called bluing agents. It has proven advantageous to use coloring agents which are soluble in water or at room temperature in liquid organic substances. Anionic coloring agents, for example anionic nitroso dyes, are suitable for example.

In addition to the aforementioned components, the washing or cleaning agents may contain further ingredients which further improve the use properties and/or esthetic properties of said agents. Preferred agents contain one or more substances from the group consisting of electrolytes, pH adjusting agents, fluorescing agents, hydrotopes, foam inhibitors, silicone oils, anti-redeposition agents, optical brighteners, graying inhibitors, shrinkage preventers, crease prevention agents, color transfer inhibitors, antimicrobial active substances, germicides, fungicides, antioxidants, antistatic agents, ironing auxiliaries, proofing and impregnation agents, swelling and anti-slip agents, and UV absorbers.

As electrolytes from the group of inorganic salts, use can be made of a large number of very varied salts. Preferred cations are the alkali and alkaline-earth metals; preferred anions are the halides and sulfates. From a production point of view, the use of NaCl or MgCl₂ in the washing or cleaning agents is preferred.

In order to bring the pH of washing or cleaning agents into the desired range, the use of pH adjusting agents may be indicated. Use can be made here of all known acids or bases, provided that the use thereof is not prohibited for use or ecological reasons, or for reasons of consumer safety. The amount of said adjusting agents usually does not exceed 1% by weight of the total formulation.

Suitable foam inhibitors are soaps, oils, fats, paraffins or silicone oils, which optionally may be applied to carrier materials. Suitable carrier materials are for example inorganic salts such as carbonates or sulfates, cellulose derivatives or silicates, as well as mixtures of the aforementioned materials. Agents which are preferred in the context of the present invention contain paraffins, preferably unbranched paraffins (n-paraffins) and/or silicones, preferably linear-polymer silicones, which are constructed according to the (R₂SiO)ₓ pattern and are also referred to as silicone oils. These silicone oils are usually clear, colorless, neutral, odorless, hydrophobic liquids having a molecular weight between 1,000 g/mol and 150,000 g/mol and viscosities between 10 mPa·s and 1,000,000 mPa·s.

Suitable anti-redeposition agents are for example nonionic cellulose ethers such as methyl cellulose and methylhydroxypropyl cellulose having a proportion of methoxy groups of from 15 to 30% by weight and of hydroxypropyl groups of from 1 to 15% by weight, in each case based on the nonionic cellulose ether.

Suitable soil repellents are the polymers of phthalic acid and/or terephthalic acid or derivatives thereof which are known from the prior art, in particular polymers of ethylene terephthalate and/or polyethylene glycol terephthalate or anionically and/or nonionically modified derivatives thereof. Among these, particular preference is given to the sulfonated derivatives of phthalic acid polymers and terephthalic acid polymers.

Optical brighteners may in particular be added to the washing agents in order to eliminate graying and yellowing of the treated textiles. These substances absorb onto the fibers and cause brightening and a simulated bleaching effect by converting invisible ultraviolet radiation into visible longer-wave light, the ultraviolet light absorbed from sunlight being emitted as slightly bluish fluorescence and resulting, with the yellow tone of the grayed or yellowed laundry, in pure white. Suitable compounds derive for example from the substance classes of 4,4′-diamino-2,2′-stilbenedisulfonic acids (flavonic acids), 4,4′ -distyrylbiphenyls, methylumbelliferones, cumarins, dihydroquinolinones, 1,3-diarylpyrazolines, naphthalic acid imides, benzoxazole, benzisoxazole and benzimidazole systems, and pyrene derivatives substituted with heterocycles.

Graying inhibitors have the task of keeping dirt that has been detached from fibers suspended in the liquor, and thus preventing redeposition of the dirt. Suitable for this purpose are water-soluble colloids, usually of organic nature, for example the water-soluble salts of polymeric carboxylic acids, size, gelatin, salts of ethersulfonic acids of starch or of cellulose, or salts of acidic sulfuric acid esters of cellulose or of starch. Water-soluble polyamides containing acid groups are also suitable for this purpose. Soluble starch preparations can also be used, for example degraded starch and/or aldehyde starches. Polyvinylpyrrolidone can also be used. Cellulose ethers such as carboxymethyl cellulose (Na salt), methyl cellulose, hydroxyalkyl cellulose, and mixed ethers such as methylhydroxyethyl cellulose, methylhydroxypropyl cellulose, methylcarboxymethyl cellulose, and mixtures thereof, can also be used as graying inhibitors.

Since textile fabrics, in particular those made of rayon, viscose, cotton and mixtures thereof, can tend to crease because the individual fibers are sensitive to bending, kinking, compression and squeezing perpendicularly to the fiber direction, synthetic crease prevention agents can be used. These include for example synthetic products based on fatty acids, fatty acid esters, fatty acid amides, fatty acid alkylol esters, fatty acid alkylolamides, or fatty alcohols, which are usually reacted with ethylene oxide, or products based on lecithin or modified phosphoric acid esters.

Proofing and impregnation methods serve to finish textiles with substances which prevent dirt from being deposited or which make it easier to wash out dirt. Preferred proofing and impregnation agents are perfluorinated fatty acids, including in the form of their aluminum and zirconium salts, organic silicates, silicones, polyacrylic acid esters having perfluorinated alcohol components, or polymerizable compounds coupled to a perfluorinated acyl or sulfonyl residue. Antistatic agents can also be contained. Dirt-repellent finishing with proofing and impregnation agents is often categorized as an “easy-care” finish. The penetration of the impregnation agents, in the form of solutions or emulsions of the relevant active substances, can be facilitated by the addition of wetting agents which lower the surface tension. A further area of use of proofing and impregnation agents is the water-repellent finishing of textile goods, tents, awnings, leather, etc. in which, in contrast to waterproofing, the fabric pores are not sealed, that is to say the material is still able to breathe (hydrophobizing). The hydrophobizing agents used for hydrophobizing cover textiles, leather, paper, wood, etc. with a very thin layer of hydrophobic groups, such as longer alkyl chains or siloxane groups. Suitable hydrophobizing agents are for example paraffins, waxes, metal soaps, etc. with added aluminum or zirconium salts, quaternary ammonium compounds with long-chain alkyl residues, urea derivatives, fatty acid-modified melamine resins, chromium complex salts, silicones, organo-tin compounds, and glutaric dialdehyde, as well as perfluorinated compounds. The hydrophobized materials are not oily to the touch, but water droplets bead up on them (in a manner similar to oiled fabrics) without wetting them. Silicone-impregnated textiles for example have a soft feel and are water- and dirt-repellent; drops of ink, wine, fruit juice and the like are easier to remove.

Antimicrobial active substances can be used in order to counteract microorganisms. A distinction is made here between bacteriostatics and bactericides, fungistatics and fungicides depending on the antimicrobial spectrum and the mechanism of action. Substances from said groups are for example benzalkonium chlorides, alkylarylsulfonates, halogen phenols, and phenol mercuric acetate, it also being possible to omit these compounds entirely.

The agents may contain antioxidants in order to prevent undesired changes to the washing and cleaning agents and/or to the treated textiles caused by the effect of atmospheric oxygen and other oxidative processes. This class of compounds includes for example substituted phenols, hydroquinones, catechols and aromatic amines, as well as organic sulfides, polysulfides, dithiocarbamates, phosphites and phosphonates.

Increased wearing comfort can result from the additional use of antistatic agents. Antistatic agents increase the surface conductivity and thus enable an improved dissipation of charges that have formed. External antistatic agents are usually substances having at least one hydrophilic molecule ligand, and yield a more or less hygroscopic film on the surfaces. These usually surface-active antistatic agents can be subdivided into nitrogen-containing antistatic agents (amines, amides, quaternary ammonium compounds), phosphorus-containing antistatic agents (phosphoric acid esters), and sulfur-containing antistatic agents (alkyl sulfonates, alkyl sulfates). Lauryl-(or stearyl-)dimethylbenzylammonium chlorides are also suitable as antistatic agents for textiles or as an additive to washing agents, an avivage effect additionally being achieved.

In order to improve the water absorption capability and rewettability of the treated textiles and to facilitate ironing of the treated textiles, silicone derivatives can be used in textile washing agents. These additionally improve the rinsing behavior of washing or cleaning agents due to their foam-inhibiting properties. Preferred silicone derivatives are for example polydialkyl- or alkylarylsiloxanes in which the alkyl groups have one to five C atoms and are entirely or partly fluorinated. Preferred silicones are polydimethylsiloxanes, which may optionally be derivatized and are then aminofunctional or quaternized or comprise Si—OH, Si—H and/or Si—Cl bonds. Further preferred silicones are the polyalkylene oxide-modified polysiloxanes, that is to say polysiloxanes which contain for example polyethylene glycols, and the polyalkylene oxide-modified dimethylpolysiloxanes.

Finally, use can also be made of UV absorbers which absorb onto the treated textiles and improve the light-fastness of the fibers. Compounds which have these desired properties are for example the compounds that act by radiationless deactivation, and derivatives of benzophenone having substituents in the 2- and/or 4-position. Also suitable are substituted benzotriazoles, acrylates phenyl-substituted in the 3-position (cinnamic acid derivatives), optionally with cyano groups in the 2-position, salicylates, organic Ni complexes, and natural substances such as umbelliferone and endogenous urocanic acid.

Protein hydrolyzates are further suitable active substances on account of their fiber-care-providing effect. Protein hydrolyzates are product mixtures which are obtained by acid-, base-, or enzyme-catalyzed breakdown of proteins. Protein hydrolyzates of both vegetable and animal origin can be used. Animal protein hydrolyzates are for example elastin, collagen, keratin, silk and milk protein hydrolyzates, which can also be present in the form of salts. It is preferred to use protein hydrolyzates of vegetable origin, for example soy, almond, rice, pea, potato and wheat protein hydrolyzates. Although the use of protein hydrolyzates as such is preferred, amino acid mixtures obtained in other ways, or individual amino acids such as arginine, lysine, histidine or pyroglutamic acid, can also optionally be used in place thereof. It is also possible to use derivatives of protein hydrolyzates, for example in the form of their fatty acid condensation products.

### EXAMPLES

### Example 1

### Synthesis of 2,3-dihydroxy-N,N′-bis(2-methoxyethyl)terephthalamide (S1)

a) Preparation of 2,3-dihydroxyterephthalic acid dimethyl ester

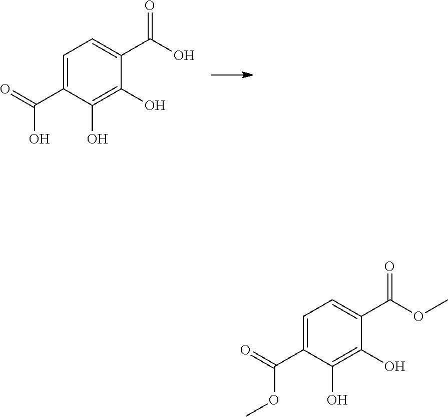 [SMILES: O=C(O)c1ccc(C(=O)O)c(O)c1O ; COC(=O)c1ccc(C(=O)OC)c(O)c1O]

96% strength sulfuric acid (3.14 g, 32 mmol) was slowly added dropwise, with stirring, to a suspension of 2,3-dihydroxyterephthalic acid (9.39 g, 45 mmol) in methanol (500 mL). The reaction mixture was heated to 65° C. and stirred at reflux for 70 h. The reaction solution was then cooled to room temperature and the solvent was removed under reduced pressure. The residue was taken up in aqueous saturated NaHCO₃ solution (300 mL) and extracted with dichloromethane (3×400 mL). The organic phase was dried with magnesium sulfate, filtered, and the solvent was removed under reduced pressure. 2,3-Dihydroxyterephthalic acid dimethyl ester (5.9 g, 26.1 mmol, 58%) was obtained as a beige solid.

b) Preparation of 2,3-dihydroxy-N,N′-bis(2-methoxyethyl)terephthalamide

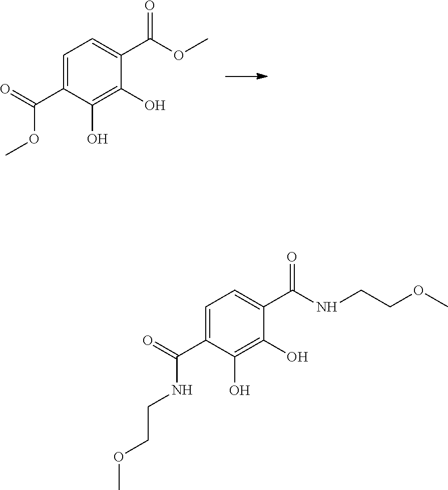 [SMILES: COC(=O)c1ccc(C(=O)OC)c(O)c1O ; COCCNC(=O)c1ccc(C(=O)NCCOC)c(O)c1O]

2,3-Dihydroxyterephthalic acid dimethyl ester (0.68 g, 3.0 mmol) from step a) was suspended in 2-methoxyethylamine (5.46 g, 72.0 mmol) and the reaction solution was reacted in the microwave (PowerMax®, T=100° C., t=4 h, power=300 W). Excess 2-methoxyethylamine was then removed under reduced pressure (2 mbar at 60° C.). The residue was recrystallized from ethyl acetate (50 mL). The ethyl acetate was decanted off; the precipitated solid was washed with a little cold ethyl acetate and dried under reduced pressure. 2,3-Dihydroxy-N,N′-bis(2-methoxyethyl)terephthalamide S1 was obtained as a beige solid (0.801 g, 2.56 mmol, 85%).

### Example 2

### Synthesis of 2,3-dihydroxy-N,N′-diethylterephthalamide (S2)

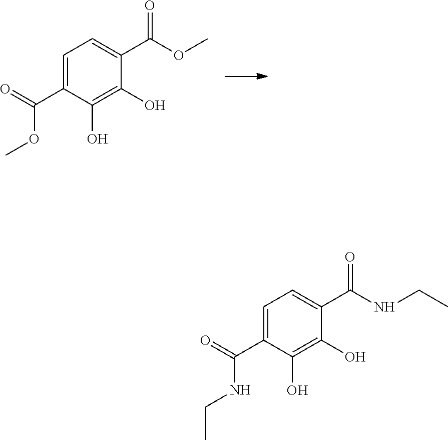 [SMILES: COC(=O)c1ccc(C(=O)OC)c(O)c1O ; CCNC(=O)c1ccc(C(=O)NCC)c(O)c1O]

2,3-Dihydroxyterephthalic acid methyl ester (0.90 g, 4.0 mmol) from Example 1 step a) was suspended in ethylamine (44 mL, 88 mmol, 2M in THF) and the reaction mixture was heated in the pressure reactor (T=100° C., t=24 h, pressure: 2.6 bar, stirrer: 250 rpm). The excess ethylamine and tetrahydrofuran was decanted off and the beige solid residue in the reactor was dissolved in methanol (70 mL). The methanol was removed under reduced pressure and the residue was recrystallized from ethyl acetate (25 mL). The ethyl acetate was decanted off; the precipitated solid was washed with a little cold ethyl acetate and dried under reduced pressure. 2,3-Dihydroxy-N,N′-diethylterephthalamide S2 was obtained as a beige solid (0.207 g, 0.82 mmol, 21%).

### Example 3

### Synthesis of the Comparative Substance 2,3-dihydroxy-N-(2-methoxyethyl)benzamide (V1)

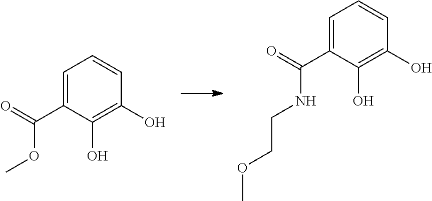

2,3-Dihydroxybenzoic acid methyl ester (0.77 g, 4.5 mmol) was dissolved in 2-methoxyethylamine (4.10 g, 54 mmol) and the reaction solution was reacted in the microwave (PowerMax®, T=100° C., t=4 h, power=300 W). Excess 2-methoxyethylamine was then removed under reduced pressure (2 mbar at 60° C.). The residue was purified by column chromatography (ethyl acetate); 2,3-dihydroxy-N-(2-methoxyethyl)benzamide V1 was obtained (0.91 g, 4.31 mmol, 96%).

### Example 4

### Synthesis of the Comparative Substance 2,3-dihydroxy-N-ethylbenzamide (V2)

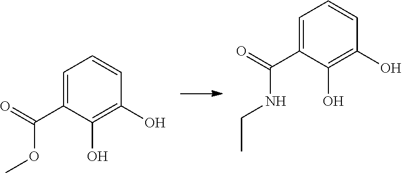

2,3-Dihydroxybenzoic acid methyl ester (1.50 g, 8.74 mmol) was suspended in ethylamine (55.6 mL, 110.12 mmol, 2M in THF) and the reaction mixture was heated in the pressure reactor (T=100° C., t=4 h, pressure: 2.5 bar, stirrer: 250 rpm). The reaction solution was concentrated under reduced pressure. The slightly viscous residue was taken up in ethyl acetate (50 mL) and washed with 1 M HCl (100 mL); after drying with magnesium sulfate and filtration, the solvent was removed from the organic phase under reduced pressure. The crude product was purified by column chromatography (CH₂Cl₂/methanol 9:1). 2,3-Dihydroxy-N-ethylbenzamide V2 was obtained as a brown, viscous residue (0.81 g, 4.47 mmol, 51%).

### Example 5

### Cleaning Performance

Washing tests at 40° C. were carried out in triplicate on standardized stains on cotton, as indicated in Table 1, wherein a bleach-free aqueous liquid washing agent (containing, besides water, 5.5% by weight 7× ethoxylated C_{12/14} fatty alcohol, 5.3% by weight sodium C₉₋₁₃ alkylbenzenesulfonate, 4.9% by weight sodium C_{12/14} fatty alcohol ether sulfate with 2 EO, 1.8% by weight citric acid, 3% by weight C₁₂₋₁₈ fatty acid, 0.1% by weight diethylenetriaminepenta(methylenephosphonic acid) hepta-sodium salt, 1.3% by weight NaOH, 3.6% by weight ethanol/glycerol) having a pH of 8.5 was used and thus washing liquors were prepared consisting of 69.3 g of the liquid washing agent or 69.3 g of the liquid washing agent and 1.39 g of one of the compounds from Examples 1 to 4, as indicated in Table 1, in each case in 17 L of water of 16° dH. The evaluation took place via color difference measurement according to the L*a*b* values and the Y values, calculated therefrom, as a measure of the brightness. The following table shows the dY values resulting from the difference Y (after washing)-Y(before washing).

TABLE 1
dY values

| Stain/compound | — | S1 | S2 | V1 | V2 |
|---|---|---|---|---|---|
| Red wine | 25.1 | 38.8 | 37.5 | 27.9 | 28.9 |
| Red grape | 21.6 | 34.8 | 37.2 | 23.4 | 24.4 |
| Blueberry | 22.2 | 36.3 | 37.3 | 26.7 | 23.5 |
| Cherry | 16.8 | 36.1 | 39.6 | 18 | 21.1 |
| Blackcurrant | 16.3 | 27.3 | 28.6 | 15.9 | 15.7 |

The dY values when using the substances essential to the invention were significantly greater than those obtained when using only the liquid washing agent or the comparative substances, which corresponds to a higher degree of whiteness and thus improved stain removal.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for improving washing or cleaning performance with respect to bleachable stains comprising the steps: (a) providing a detergent or cleaning agent comprising a compound of general formula (I), and (b) bringing a textile having bleachable stains into contact with the detergent or cleaning agent, 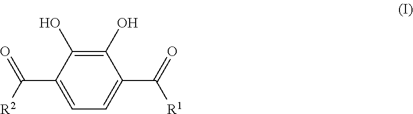
wherein R¹ and R² independently of one another are NR³R⁴ or OR⁵;
wherein R³, R⁴ and R⁵ independently of one another are H or a cyclic or acyclic, straight-chain or branched-chain, aliphatic or aromatic hydrocarbon residue having 1 to 20 carbon atoms,
wherein the backbone of the hydrocarbon residue is optionally interrupted by one or more non-adjacent heteroatoms and/or is optionally substituted with OH groups or NH₂ groups at C atoms of the backbone not bound to the heteroatoms; and
wherein the heteroatoms are selected from O atoms, N atoms, or a mixture thereof

2. The method according to claim 1, wherein the stains comprise polymerizable substances.

3. The method according to claim 2, wherein the polymerizable substances are polyphenolic dyes.

4. The method according to claim 2, wherein the polymerizable substances are flavonoids.

5. The method according to claim 2, wherein the polymerizable substances are dyes in the class of anthocyanidins or anthocyanins, or oligomers thereof.

6. The method according to claim 1, wherein the improved washing or cleaning performance lies in an improved removal of green, yellow, red, blue, violet, purple, brown, magenta or pink stains.

7. The method according to claim 1, wherein the stains are selected from stains caused by cherries, sour cherries, grapes, apples, pomegranates, aronia, plums, buckthorn, acai, kiwis, mangoes, grass, redcurrants, blackcurrants, elderberries, blackberries, raspberries, blueberries, lingonberries, cranberries, strawberries, bilberries, coffee, tea, red cabbage, blood orange, eggplant, tomato, carrot, beetroot, spinach, bell pepper, red or blue potato, red onion, spices, sauces, chutneys, curries, purees, jams, wines, and/or juices.

8. The method according to claim 1, wherein, in the compounds of general formula (I), R¹ and R² are identical.

9. The method according to claim 1, wherein, in the compounds of general formula (I), R³ is H.

10. The method according to claim 1, wherein, in the compounds of general formula (I), R⁴ and R⁵, independently of one another, are alkyl groups, alkoxyalkyl groups, hydroxyalkyl groups, or aromatic groups.

11. The method according to claim 10, wherein, in the compounds of general formula (I), R⁴ and R⁵, independently of one another, are selected from the group consisting of methyl, ethyl, n-propyl, i-propyl, methoxyethyl, methoxypropyl, (2-methoxy)ethoxyethyl, ethoxyethyl, ethoxypropyl, (2-ethoxy)ethoxyethyl, hydroxyethyl, hydroxypropyl, 2-hydroxypropyl, 1,2-dihydroxypropyl, 2-hydroxyethoxyethyl, (N-hydroxyethyl)aminoethyl, (N-methoxyethyl)aminoethyl, (N-ethoxyethyl)aminoethyl, phenyl, and benzyl.

12. A washing or cleaning agent comprising 0.001% by weight to 20% by weight of a compound of general formula (I) 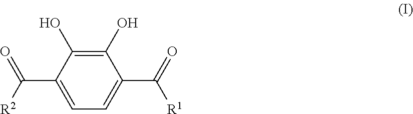
wherein R¹ and R², independently of one another, are NR³R⁴ or OR⁵;
wherein R³, R⁴ and R⁵, independently of one another, are H or a cyclic or acyclic, straight-chain or branched-chain, aliphatic or aromatic hydrocarbon residue having 1 to 20 carbon atoms,
wherein the backbone of the hydrocarbon residue is optionally interrupted by one or more non-adjacent heteroatoms and/or is optionally substituted with OH groups or NH₂ groups at C atoms of the backbone not bound to the heteroatoms; and
wherein the heteroatoms are selected from O atoms, N atoms, or a mixture thereof.

13. The agent according to claim 12, wherein the compound of formula (I) is in an amount of 0.01% by weight to 10% by weight.

14. The agent according to claim 12, wherein R¹ and R² are identical.

15. The agent according to claim 12, wherein R³ is H.

16. The agent according to claim 12, wherein R⁴ and R⁵, independently of one another, are alkyl groups, alkoxyalkyl groups, hydroxyalkyl groups, or aromatic groups.

17. The agent according to claim 16,
wherein independently of one another, are selected from the group consisting of methyl, ethyl, n-propyl, i-propyl, methoxyethyl, methoxypropyl, (2-methoxy)ethoxyethyl, ethoxyethyl, ethoxypropyl, (2-ethoxy)ethoxyethyl, hydroxyethyl, hydroxypropyl, 2-hydroxypropyl, 1,2-dihydroxypropyl, 2-hydroxyethoxyethyl, (N-hydroxyethyl)aminoethyl, (N-methoxyethyl)aminoethyl, (N-ethoxyethyl)aminoethyl, phenyl, and benzyl.

18. The agent according to claim 12, wherein the washing or cleaning agent does not include a bleaching agent selected from hypochlorites, hydrogen peroxide, or substances yielding hydrogen peroxide.

19. The agent according to claim 12, wherein the agent is a liquid textile washing agent or a powdered or liquid color washing agent.
